(19) United States
(12) Patent Application Publication
(10) Pub. No.: US 2009/0141292 A1
(43) Pub. Date: Jun. 4, 2009

(54) PREDICTIVE PACKAGER FOR DIGITAL IMAGE PROCESSING

(75) Inventors: Harold Adams, New Braunfels, TX (US); Harold Blankenship, New Braunfels, TX (US); David J. Oles, San Marcos, TX (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: DNP PHOTO IMAGING AMERICA CORP., San Marcos, TX (US)

(21) Appl. No.: 12/328,173

(22) Filed: Dec. 4, 2008

Related U.S. Application Data
(60) Provisional application No. 61/005,355, filed on Dec. 4, 2007.

(51) Int. Cl. H04N 1/00

(52) U.S. Cl. 358/1.6

(57) ABSTRACT

The present invention provides a method for printing digital images wherein concurrent with selection of an image by a user, the image is rendered and placed on a storage location before a print order is completed, and printing the image upon selection of a print command. Multiple images may be rendered and placed on the storage location prior to the completion of the print order and printing of all or some of the images will not begin until the print command is given. In another embodiment of the present invention, the images may be placed in a separate cache memory and transferred to a printer buffer upon selection of the print command. A user may create an edited image after the image has been initially selected, rendered, and placed on the storage location. The edited image may then replace the original image on the storage location until the print command is given.

### CROSS-REFERENCE TO RELATED APPLICATIONS

This application is based upon and claims benefit of co-pending and co-owned U.S. Provisional Patent Application Ser. No. 61/005,355 entitled “PREDICTIVE PACKAGER FOR DIGITAL IMAGE PROCESSING,” filed with the United States Patent and Trademark Office on Dec. 4, 2007 by the inventors herein, the specification of which is incorporated herein by reference in its entirety.

### BACKGROUND OF THE INVENTION

1. Field of the Invention

This invention relates to digital image processing and, more particularly, to packaging digital images for expedited processing and printing.

2. Background

Digital printing technology, such as dye sublimation or ink jet printing, is rapidly replacing conventional silver halide (AgX) printing technology in the marketplace. Historically, users would operate cameras to expose film, take the exposed film to a photo retailer and then later return to pick-up their processed pictures. As digital photography has evolved and become prevalent, however, the majority of images are now captured using digital cameras. The availability of computers for the processing and printing of digital images has made it possible for photographs to be printed anywhere. Photographers, either amateurs or professionals, have the option of printing their images at home or their office without the need to go to a photography lab. Professional printing, however, still requires specialized printers. Such printers can now be found at the traditional photography lab, but more frequently at general retail locations through the use of self serve photo kiosks.

Whether at a self-serve photo kiosk or at home, the typical photo printing workflow consists of a user inserting their digital media card, such as SD media, into a digital media card slot on a photo kiosk or a card reader in the user's personal computer. In some instances, the user may be able to connect their digital camera directly to a computer through the use of a USB cable or similar device. The kiosk/computer software automatically detects the images on the inserted media or the user touches the screen and initiates the loading process. Screen resolution preview images are displayed for the user. The user selects the images and quantity that they would like to print. Most kiosks (or host applications) include the ability to edit images (user edits). Editing images may include, for example, cropping, adjusting color or density, removing red eye, adding text, or adding digital frames to an image. The user then typically completes their order and waits for the prints to be produced.

When a user completes his order, the host application software begins to process the order by preparing the image data for printing. The process is usually referred to as “rendering” the image. Rendering may involve opening the full resolution image file, applying user edits such as cropping and color adjustment, scaling and cropping the image for the selected printer and print size, and applying color management profiles for the specified printer. Once rendered an image is transferred to the printer's memory buffer. Upon transfer to the printer's memory buffer, the actual print process begins automatically.

The amount of time required for rendering and printing depends upon the performance of the host computer, the size of the customer's image file, the complexity of the user edits, the efficiency of the rendering algorithm in the host application and the speed of the data interface between the host computer and the attached printer(s). The actual time to render each image is typically between 2 and 10 seconds per image with most modern printers having an approximately 10 second print time per each 4×6 print. This makes the time for the first print to complete somewhere between 12 and 20 seconds.

In order to increase print speeds and to decrease the amount of time it takes to complete a user's order, it has become common to attach multiple printers to a single photo kiosk or digital minilab. As the number of printers attached to a system has increased it has become more important to develop a highly efficient rendering system so that the printers can produce pictures at the maximum possible rate.

It is particularly desirable to reduce the amount of time for the actual printing process to begin for the first and subsequent prints. The time for first print is considered an important attribute for a photo kiosk. “Time to first print” has been used as a scoring parameter in the Digital Imaging Marketing Association's (DIMA) annual kiosk competition for several years. The time to first print is important as users have become more and more accustomed to immediate response by electronics. Time to first print is important to retailers as it can be a differentiator and it leads to faster user turn-over at each kiosk terminal.

Thus, a need exists to provide a method and system by which the time required for processing and rendering digital images in a consumer's image print order can be minimized so as to, in turn, minimize the time to first print and thus the consumer's wait for completion of their image print order.

### SUMMARY OF THE INVENTION

The present invention provides, in one embodiment, a method for printing digital images wherein upon selection of an image by a user, the image is rendered and placed in a storage location (such as a cache memory or a printer buffer) before a print order is completed, and printing the image upon selection of a print command. Multiple images may be placed in the storage location and printing of all or some of the images will not begin until the print command is given. In another embodiment of the present invention, the images may be placed in one storage location (e.g., a cache memory) and then transferred to a second storage location (e.g., the printer buffer) upon selection of the print command. It is further contemplated that the user may create an edited image after it has been initially selected, rendered, and placed on the storage location. The edited image can then replace the original image on the storage location. By initiating rendering of images prior to finalizing a user's print order, i.e., during the process of selecting and/or editing multiple images that are to comprise the user's print order, at least a portion of the rendering task is completed at an earlier stage in the overall printing process, thus reducing the time to first print.

Upon selection of the image for printing, an image message may be created and sent to a rendering engine in order to process the printing request. The image message may consist of an image path, the size of the prints to be printed, the quantity of prints and any other information that may be required for processing the request.

In a further embodiment of the present invention, a computer program product comprising a computer usable medium having a computer readable program code adapted to be executed to implement the method of printing digital images described above is provided. Another embodiment of the present invention provides for an image processing and printing unit for printing photographs using the method of printing digital photographs described above.

### BRIEF DESCRIPTION OF THE DRAWINGS

FIG. 1. is an illustration of a image processing and printing unit according to one embodiment of the present invention.

FIG. 2. is a schematic diagram of a method for printing digital images according to one embodiment of the present invention.

FIG. 3. is a schematic diagram of a method for rendering images according to one embodiment of the present invention

### DETAILED DESCRIPTION

The invention summarized above may be better understood by referring to the following description, which should be read in conjunction with the accompanying claims and drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

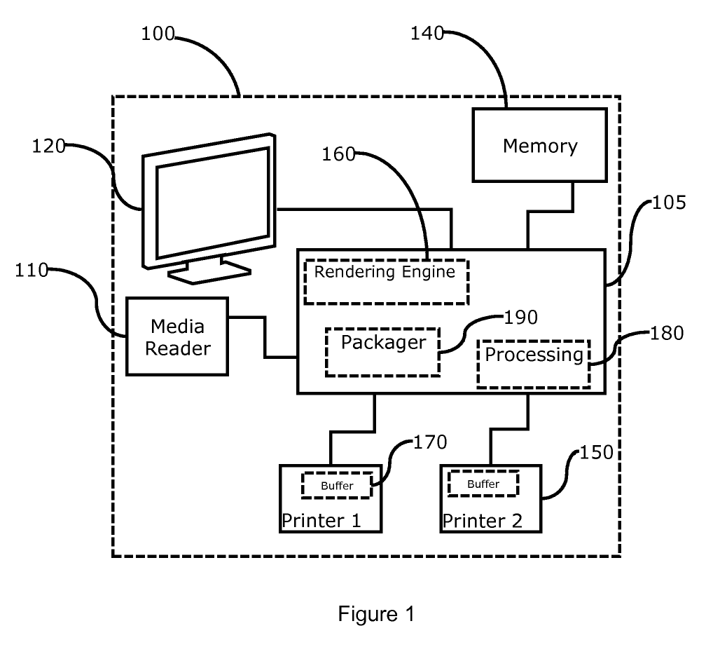

With regard to a first particularly preferred embodiment of the invention, as shown in FIG. 1, an image processing and printing unit 100 is a system that may be utilized for printing digital images, such as a photograph kiosk. The image processing and printing unit 100 preferably includes a processing unit 105 in communication with preferably at least one media reader 110, a user interface 120, storage location (e.g., memory 140 or printing buffer 170); and one or more printers 150. The user interface 120 may comprise any means understood by a person of ordinary skill in the art to allow a user to interact with the image processing and printing unit 100. For example, user interface 120 may be a touch screen that allows a user to make necessary selections, a combination of a screen and a keyboard, or voice recognition component that allows a user to make his or her selections by speaking to the image processing and printing unit 100. The user interface 120 allows the user to enter and upload data in the form of text messages and/or graphic images.

The image processing and printing unit's 100 media reader 110 allows a user to transfer or upload images into the system for printing. The media reader 110 may allow the user to upload images from many different types of media, such as SD memory cards, flash cards, thumb-drives, USB-storage devices, digital cameras and other such devices that may store images or other types of data and may be connected to a media reader 110 to facilitate transfer of the images to the image processing and printing unit 100. It is contemplated that the images can be transferred to the image processing and printing unit 100 in a variety of known formats, such as TIFF, JPEG, PDF and various other formats as recognized in the art.

The processing unit 105 may be a standard general purpose CPU, a server on a network to which the image processing and printing unit 100 is connected, an ASIC designed specifically to carry out the function of the image processing and printing unit 100, or any similar device that allows the image processing and printing unit 100 to implement the algorithms required for its function. The image processing and printing unit 100 is preferably provided processing software 180 that allows the user to select individual images for printing, edit those images, and complete their print order to initiate a print function. Likewise, a rendering engine 160 may also run on such a CPU, or on a server or other computer connected to the image processing and printing unit 100 through a network. In any configuration, the user interface 120, the processing software 180, the rendering engine 160, and one or more printers 150 are in data communication so as to allow input, processing, rendering, and printing of user selected images as described herein.

The processing unit 105 may be connected to one or more printers 150 in a variety of different ways. For example, the processing unit 105 may be physically connected to the printers through a USB or serial port, or a network in the form of a LAN, WAN, or a wireless connection. The printer 150 or printers each may have a printing memory buffer 170 onto which images may be transferred for printing. The printing memory buffer 170 may hold one or more pictures at a time as the print job is being completed. In some instances, a print job from a user may be divided into different batches and each batch sent to the printing memory buffer 170 of each different printer 150 in order to increase performance and reduce printing time.

The image processing and printing unit 100 may also contain a predictive packager 190 that manages the printing process. The predictive packager 190 may run on the processing unit 105 or a server to which the image processing and printing unit 100 is connected. The predictive packager 190 may also be stored in a computer usable media that manages the image processing and printing unit's 100 operations and implements a method of the present invention as described below. Computer usable media may include, by way of non-limiting examples, a hard drive, a CD-ROM, a DVD, a thumb drive, a zip drive, a server in communication with the image processing and printing unit 100, and any other type of media with sufficient capacity to store and manage a computer program for use with the image processing and printing unit 100.

In a preferred embodiment of the present invention, a method for printing digital images is provided in which the image processing and printing unit receives a selection of images to be printed. Concurrent with receiving the image, the process of rendering the image is initiated and, and once rendered, the image is placed in a storage location. Once the user is ready to complete the order, the image processing and printing unit receives a print command and then proceeds to print the images from the storage location.

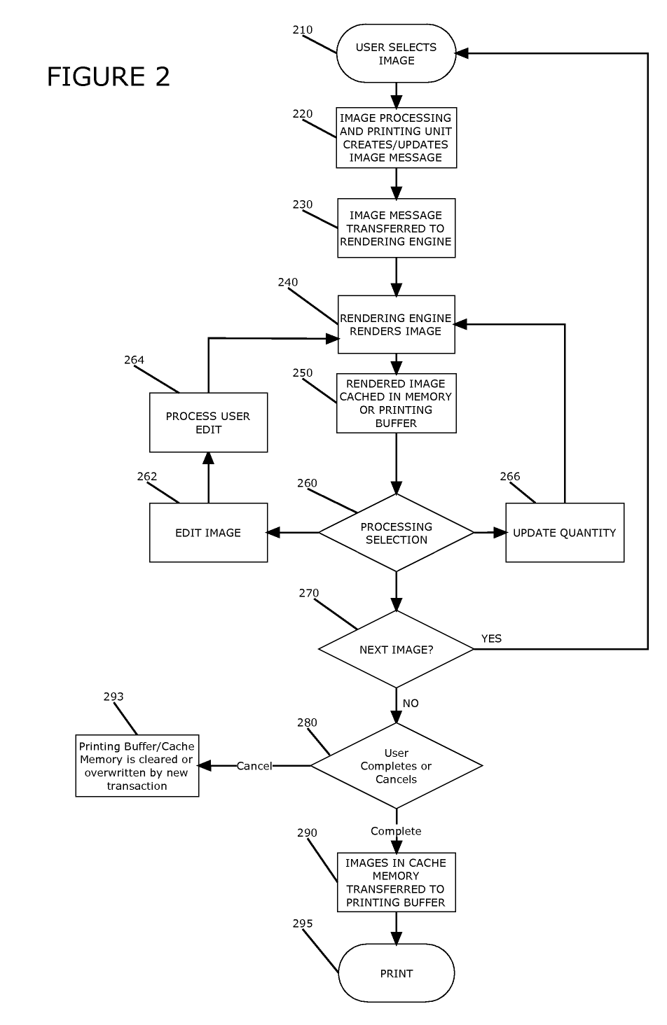

As shown in the schematic view of FIG. 2, a process is provided by which the time required for the printing process to begin for the first print and subsequent prints may be reduced through management of the image rendering process. More particularly, images are continuously rendered during the user's interaction with the user interface to select and edit images. Thus, when the user's print job order is completed and the user finalizes the order for printing, little or no rendering effort remains and the print function may begin more quickly than if the user's print job order still needed to be rendered.

At step 210, a user engages the user interface and selects an image that they wish to add to the print job order (if the user is selecting more than one image or if the image is further edited as described below, this image would be considered a first image). The user may select the image/first image by checking a box in the user interface, setting an order quantity of greater than zero for such image/first image, or any other method contemplated by a person of ordinary skill in the art that allows the system to identify a picture for printing. At step 220, which occurs concurrently with receipt of the selection from step 210, the predictive packager software creates an image message preferably consisting of selection criteria utilized in step 210, such as the image path (i.e., the location of the particular image file that is to be included in the print job order), the selected print size, and the selected quantity. At step 230 the image message is transferred to a rendering engine. At step 240, the rendering engine renders the image. The rendered image/first image is then transferred to a storage location, which may be a cache memory or a printer memory buffer.

The user may then at step 260 make a processing selection, including editing the first image at step 262 (e.g., cropping, color and density adjustment, red eye reduction, adding text or digital frames, etc.), updating the quantity of prints for the selected image/first image at step 266, selecting another image to process at step 270, or finalizing their order at step 280. When the user selects a new image or edits the first image, the resulting image is referred to herein as a “second image.” This “second image” is an image that was originally rendered and has further been edited and rendered a second time. A “second image” is also an image that is selected after the first image. It is contemplated that the process will continue until the user has selected all of the images that he or she would like to print.

If the user elects at step 260 to edit the currently selected image, then the user engages an edit image function at step 262 and at step 264 the user edit is processed (as described in detail below with particular reference to FIG. 2). Thereafter, the user may again apply additional user edits, update the quantity of the selected image, select another image to add to the print job order, or finalize their order. If the user elects at step 260 to update the quantity of prints for the selected image, the image message is updated for that selected image at step 266, and the user is again presented with the options of making further edits, updating print quantity, selecting another image, or finalizing their order. Last, if at step 260 a user elects to process another image, then at step 270 the user selects another image to add to the print job order, the predictive packaging software returns to step 210 and proceeds through the process of generating a new image message, transferring the new image message to the rendering engine, rendering the image, and placing the newly rendered image in the storage location such as memory or in a printing buffer available from one or more printers. Such “next image” selection by the user may include an image that the user and the system have not previously rendered, or an image that has been previously rendered and cached or transferred to a printing buffer but which the user now desires to modify.

After the user has selected all of the images they desire to add to the print job order and has applied all of the user edits they intend to apply, at step 280 the user may finalize their order by providing a printing command. Such printing command may be the selection of an “order complete,” “checkout,” “print” or any other option provided to the user that indicates the transaction has been finalized and that printing may begin. The user may also be given the option to cancel the order at step 280. If the user cancels the order, then the images in cache memory or residing in the printer buffer are deleted or overwritten at step 293 when a new printing process begins. Once the user's print job order has been finalized, at step 290 any images already in the printer buffer for the particular order begin to print at step 295 and any cached images are transferred to the printer's memory buffer as space becomes available for printing.

Optionally, the processing software may impose a limit on the number of pre-rendered images that may be cached in memory or a printing buffer, which limit specifies the number of pre-rendered images that are preferred in order to speed up printing. Such number may optionally be modified to allow a system operator to take best advantage of the system's processing capabilities in light of print speed limitations for the particular printers used in the system.

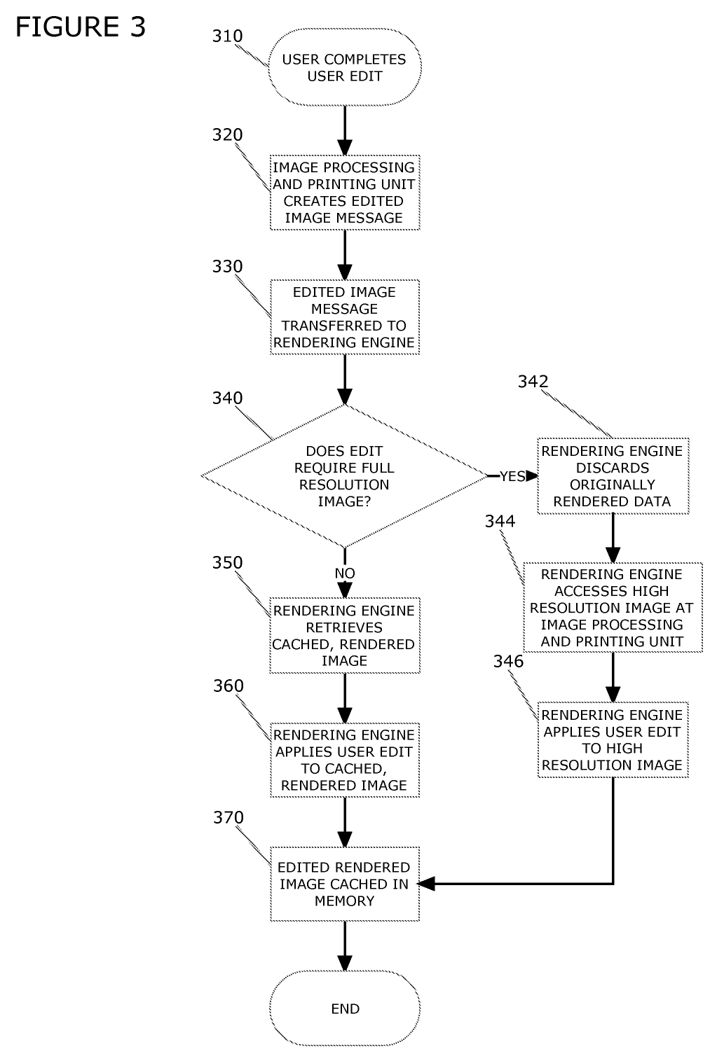

As shown in the schematic view of FIG. 3, processing the user edit first requires that the user indicate the particular edit they wish to apply. Once that edit has been selected by the user at step 310, an edited image message is generated at step 320, and at step 330 that edited image message is transferred to the rendering engine. Further processing of the image/first image by the rendering engine then depends on the particular type of user edit that the user has selected. Particularly, some user edits (such as red eye reduction) must be applied to the full resolution image stored on the user's digital media card, while other less complex user edits may be applied to a modified image of lesser resolution, such as an image that has already been rendered by the rendering engine. Thus, at step 340, the rendering engine detects whether or not the user edit requires the full resolution image. If so, at step 342, the rendering engine discards the originally rendered data, and at step 344 the rendering engine accesses the high resolution image on the user's digital media card at the image processing and printing unit's CPU (or any other memory device on which the high resolution image is stored). At step 346, the rendering engine then applies the user edit to the high resolution image.

If, at step 340, the rendering engine detects that the full resolution image is not required, then at step 350 the rendering engine retrieves the previously cached (or printing buffer first image), rendered image and at step 360 the rendering engine applies the user edit to the cached (or printing buffer image), rendered first image. Following each of steps 346 and 360, the edited rendered image (or second image) is then stored in a storage location such as cache memory (or an available printing buffer) at step 370, at which point (referring again to FIG. 1) the user proceeds to step 260 and may select another image, apply additional user edits, or finalize their print job order to proceed with printing.

If, at step 340, the rendering engine is still rendering or has not yet rendered the first image at step 240 (e.g., because the rendering engine is processing images previously selected by the user), then the user edit may be applied as the initial rendering proceeds (i.e., without retrieving a previously cached image).

With regard to a first alternate embodiment of the invention, if at step 260 a user elects to apply a user edit to the image, steps 320 and 330 (creating the edited image message and transferring the edited image message to the rendering engine) may be automatically initiated when the user exits the image editing area of the processing software, or when the user selects another image for editing which indicates that the user has stopped editing the first image. Thus, multiple user edits may be included in the edited image message so that only a single edited image rendering is necessary (as opposed to the above-described method of re-rendering the image after each user edit was selected).

With regard to another alternate embodiment of the invention, after an image is rendered (whether edited or unedited), the rendered image may be transferred to the printer's memory buffer, but the actual print process is not started. If, after such transfer to the printer's memory buffer, the user performs an edit of the transferred image, that image may be re-rendered and the printer's memory buffer overwritten with or erased and replaced by the newly rendered data. Once the user order is finalized, the actual print process is then initiated.

With regard to yet another embodiment of the invention, steps 320 through 350 (creating the image message, transferring the image message to the rendering engine, rendering the image and caching the rendered image in memory) may proceed as soon as the user selects an image (i.e., without requiring the user to select a particular number of images to be printed). In this case, the processing software may provide a default image quantity immediately upon the user's selection of an image (e.g., automatically defaulting to “double prints”).

With regard to still yet another embodiment of the invention, steps 320 through 350 may proceed as soon as the host application begins to load images from the user's digital media (i.e., before the user makes selections of specific images). As above, the processing software may provide a default image quantity for each image. If the user does not select a particular rendered image for printing, such rendered image is preferably erased from memory when the user finalizes their print job order at step 380.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A method for printing digital images comprising:
receiving a selection of an image;
concurrent with said receiving step, initiating rendering of the image;
placing the image in a storage location;
receiving a print command; and
printing the image.

2. The method for printing digital images of claim 1, further comprising:
replacing the image on the storage location with an edited image created after said rendering and placing steps, and before said printing step.

3. The method for printing digital images of claim 1, wherein said rendering step comprises:
sending an image message to a rendering engine after said selecting step.

4. The method for printing digital images of claim 3, wherein the image message consists of at least one of an image path, a print size, or a selected quantity.

5. The method for printing digital images of claim 1, wherein said storage location is selected from the group consisting of a cache memory and a printing buffer.

6. A computer program product comprising a computer usable medium having a computer readable program code adapted to be executed to implement a method for printing digital images, said method comprising:
receiving a selection of an image;
concurrent with said receiving step, initiating rendering of the image;
placing the image in a storage location;
receiving a print command; and
printing the image.

7. The computer usable product of claim 6, wherein said method further comprises:
replacing the image on the storage location with an edited image created after said rendering and placing steps and before said printing step.

8. The computer usable product of claim 6, wherein said method further comprises:
sending an image message to a rendering engine after said selecting step.

9. The computer usable product of claim 8, wherein the image message consists of at least one of an image path, a print size, or a selected quantity.

10. The computer usable product of claim 6 wherein said storage location is selected from the group consisting of a cache memory and a printing buffer.

11. A system for printing digital images comprising:
an image processing and printing unit; and
a computer usable medium having a computer readable program code adapted to be executed in said image processing and printing unit to implement a method for printing images, said method comprising:
receiving a selection of an image;
concurrent with said receiving step, initiating rendering of the image;
placing the image in a storage location;
receiving a print command; and
printing the image.

12. The system for printing digital images of claim 11, further comprising:
replacing the image on the storage location with an edited image created after said rendering and placing steps, and before said printing step.

13. The system for printing digital images of claim 11, wherein said rendering step comprises:
sending an image message to a rendering engine after said selecting step.

14. The system for printing digital images of claim 13, wherein the image message consists of at least one of an image path, a print size, or a selected quantity.

15. The system of claim 11 wherein said storage location is selected from the group consisting of a cache memory and a printing buffer.

16. A method for printing digital images comprising:
receiving a selection of a first image;
concurrent with said receiving step, initiating rendering of said first image;
placing said first image in a storage location;
after initiating rendering of said first image, receiving a selection of a second image;
rendering said second image;
placing said second image in said storage location;
receiving a print command; and
printing at least said second image.

17. The method for printing digital images of claim 16, wherein said second image is an edited first image.

18. The method for printing digital images of claim 16, further comprising:
sending an image message to a rendering engine after said selecting step.

19. The method for printing digital images of claim 18, wherein the image message consists of at least one of an image path, a print size, or a selected quantity.

20. The method for printing digital images of claim 16 wherein said storage location is selected from the group consisting of a cache memory and a printing buffer.

21. A computer program product, comprising a computer usable medium having a computer readable program code adapted to be executed to implement a method for printing digital images, said method comprising:
receiving a selection of a first image;
concurrent with said receiving step, initiating rendering of said first image;
placing said first image in a storage location;
after initiating rendering of said first image, receiving a selection of a second image;
rendering said second image;
placing said second image in said storage location;
receiving a print command; and
printing at least said second image.

22. The computer usable product of claim 21, wherein said second image is an edited first image.

23. The computer usable product of claim 21, wherein said method further comprises:
sending an image message to a rendering engine after said selecting step.

24. The computer usable product of claim 23, wherein the image message consists of at least one of an image path, a print size, or a selected quantity.

25. The computer usable product of claim 21 wherein said storage location is selected from the group consisting of a cache memory and a printing buffer.

26. A system for printing digital images comprising:
an image processing and printing unit; and
a computer usable medium having a computer readable program code adapted to be executed in said image processing and printing unit to implement a method for printing images, said method comprising:
receiving a selection of a first image;
concurrent with said receiving step, initiating rendering of said first image;
placing said first image in a storage location;
after initiating rendering of said first image, receiving a selection of a second image;
rendering said second image;
placing said second image in said storage location;
receiving a print command; and
printing said at least said second image.

27. The system for printing digital images of claim 26, wherein said second image is an edited first image.

28. The system for printing digital images of claim 26, wherein said rendering step comprises:
sending an image message to a rendering engine after said selecting step.

29. The system for printing digital images of claim 28, wherein the image message consists of at least one of an image path, a print size, or a selected quantity.

30. The system for printing digital images of claim 26 wherein said storage location is selected from the group consisting of a cache memory and a printing buffer.
